(19) United States
(12) Patent Application Publication
(10) Pub. No.: US 2020/0218734 A1
(43) Pub. Date: Jul. 9, 2020

(54) System and Method of Single Control Plane for Data Ingestion

(71) Applicant: ThinkData Works Inc., Toronto (CA)

(72) Inventors: Brendan Stennett, Toronto (CA); Bryan Smith, Toronto (CA)

(73) Assignee: ThinkData Works Inc.

(21) Appl. No.: 16/733,508

(22) Filed: Jan. 3, 2020

Related U.S. Application Data
(60) Provisional application No. 62/788,782, filed on Jan. 5, 2019.

(51) Int. Cl. G06F 16/28; G06F 16/242

(52) U.S. Cl. CPC G06F 16/283; G06F 16/242

(57) ABSTRACT

A method is provided for ingesting datasets into existing data warehouses, which are associated with data warehouse references. A selection of a data warehouse reference into which a dataset is to be loaded is received from a user. The dataset is accessed and its regional and format particulars are determined. Available data warehouses associated with the selected data warehouse reference are determined. Based on the regional and format particulars, a data warehouse is selected from these available data warehouses. A current address of the selected data warehouse is retrieved. The dataset is ingested directly into the selected data warehouse at the current address without further input from the user or knowledge of the current address by the user. A method of migrating between existing data warehouses with ingested data is also provided.

### FIELD OF INVENTION

The invention in general relates to Big Data and in particular to the ability to more efficiently deal with a variety of data that is constantly updated.

### BACKGROUND OF THE INVENTION

It has become easier and cheaper to gather data due to many different improvements in technology and changes in user behaviour. As a result, large and complex datasets have evolved which are referred to as Big Data. Generally, the term Big Data refers to large datasets that are too large or too complex to be dealt with using traditional data processing techniques.

Big Data challenges include capturing data, data storage, data analysis, search, sharing, transfer, visualization, querying, updating, information privacy and data protection. There are a number of different problem areas in the Big Data ecosystem that each have their own complexities. On the technical side, there are the problems of volume, velocity, and variety. Volume refers to the raw size of the incoming data and the challenges associated with querying and storing such a large dataset that may not be able to reside on a single storage medium or computer. Velocity refers to the speed at which data is updating and the challenges associated with processing this at least as fast as it is coming in to avoid backlog. Variety refers to the challenges associated with the number of different ways data can be represented in terms of varied file formats, varied schemas, and varied data point representations.

Prior art has users deal with the various differences in a manual fashion, having humans selecting and arranging various techniques in order to transform the data from its transit format to one that can be interpreted and loaded into a data warehouse. This can be particularly time consuming, especially when having to deal with the large variety of datasets.

It would be advantageous to have a mechanism to analyze the incoming data and automatically make the necessary adjustments in order to properly warehouse it to use the data for analysis. It would also be useful if the system could abstract away changes in file format, compression format, or data point representation so as to not render a user's integration in a broken state.

### SUMMARY

Broadly speaking, the present invention provides a method and a system of a single control plane for data ingestion and query that may preferably be used to house Big Data in warehouses spread out over multiple geographic locations.

The system and methods of the invention aim to remove the complexity from the application layer by providing a single control plane for data access. Thus, an application or a user only needs to connect with the single control plane which in turn enables connection to the various data warehouses associated with it.

A Single Control Plane (SCP) is intended to be a single system for managing the integrations of various datasets coming from possibly various computer systems located in possibly different geographic locations. It is intended to be the controller to manage the ingestion of a dataset from one location into a specified data warehouse. The SCP may preferably manage the connections to the data warehouses so each user adding new data into the system need not maintain a manifest of connection credentials to various data warehouses, but instead need only interact with a single system and select which already pre-configured warehouse data should be loaded into. A manifest in computing is a file containing metadata for a group of accompanying files that are part of a set or coherent unit. A manifest can be a file, a database or an in-memory reference. The manifest may contain a Load Marker and a Query Marker.

In one embodiment, the system and method manages the querying of these data warehouses after they have had data loaded into them so various users need not maintain a manifest of connection credentials, or even know that one dataset now resides in a different data warehouse than before (or has been split across multiple warehouses), but instead the single control plane maintains the list of pre-configured warehouses, and the record of which dataset has been loaded where, so when a user queries the data, the system automatically and seamlessly forwards that query to the appropriate data warehouse.

In one embodiment, the system and method enables a layer of abstraction away from the user to not only reduce the amount of complexity of dealing with many data warehouses, but also seamlessly protects the user from a migration event where a dataset has been moved from one data warehouse to another breaking a configured integration of said data.

In one embodiment, the system and method also adds a layer of security because the single control plane can have global visibility into who is querying data and from where but can also cut-off access for a user for all data warehouses at once.

Big Data refers to large datasets that are too large or too complex to be dealt with using traditional data processing techniques. Big Data challenges include capturing data, data storage, data analysis, search, sharing, transfer, visualization, querying, updating, information privacy and data protection.

In one embodiment of the invention the functionality of the single control plane for data ingestion of instant invention may be embedded in another platform.

In another embodiment of the invention the functionality and inventive aspects of the single control plane for data ingestion of invention may be associated with a control plane for accessing data from a single logical place even if the data resides in separate physical locations. This allows for abstracting away the complexity of storing data in different warehouses due to data residency requirements, performance requirements, etc. from the users accessing the data.

In one embodiment of the invention an Enterprise Data Warehouse (EDW) may store any one of the different data types e.g. files, databases, audio, video, mixed media, encrypted data. The application cites several examples of data types, in fact the intent is to cover all such data types that may exist currently or will be developed or may evolve over time as a result of the advancements in the different fields of computing.

According to a first aspect of the invention, a method is provided for ingesting datasets into existing data warehouses, which are associated with warehouse references. A selection of a data warehouse reference into which a dataset is to be loaded is received from a user. The dataset is accessed and its regional and format particulars are determined. Available data warehouses associated with the selected reference are determined. Based on the regional and format particulars, a data warehouse is selected from these available data warehouses. A current address of the selected data warehouse is retrieved. The dataset is ingested directly into the selected data warehouse at the current address without further input from the user or knowledge of the current address by the user.

The method may further include configuring, cleaning or reformatting the dataset prior to loading it into the selected data warehouse.

The method may further include making the dataset available for query once ingested based on the data warehouse reference. The query may be tailored for a preferred query format of the data warehouse.

Preferably, a region of the dataset matches the region of the selected data warehouse.

Preferably, a language of the dataset matches a language of the selected data warehouse.

Preferably, a format of the dataset matches a format of the selected data warehouse.

The ingesting step may be done by: real time, batchwise, or lambda architecture processes.

In a preferred embodiment, every dataset has a Load Marker and a Query Marker associated with it. The Load Marker may be set or reset before the ingesting step. The Query Marker may also be set or reset after the ingesting step.

According to a second aspect of the invention, a method is provided for migrating between existing data warehouses. The data warehouses are associated with data warehouse references. A first data warehouse associated with a data warehouse reference is established, and data is loaded into the first data warehouse. A second data warehouse is established. When migration from the first to the second data warehouse is to occur, a load marker is switched from the first to the second data warehouse. A new revision of the dataset is then automatically directable to the second data warehouse after the migration.

The method may include moving data from the first data warehouse into the second data warehouse.

The method may include copying data from the first data warehouse into the second data warehouse.

The method may include deleting (or pruning) data from the first data warehouse after the migration.

The method may include switching a hot/cold marker on the first data warehouse to cold after the migration.

The method may include switching a hot/cold marker on the second data warehouse to hot after the migration.

In some embodiments, the second data warehouse may be in a different region than the first data warehouse. In this case, the method may include moving or copying data from the first data warehouse into the second data warehouse, and reformatting the moved or copied data for the region of the second data warehouse.

The method may include automatically ingesting new datasets into the second data warehouse after the migration.

The method may include automatically switching a query marker from the first to the second data warehouse. In this case, the method may include receiving a query related to a dataset and automatically directing the query to the second data warehouse. A query counter may be updated as each query is received. The method may include setting or resetting a hot/cold marker based on the query counter.

### BRIEF DESCRIPTION OF THE FIGURES

FIG. 1 is a schematic diagram of a preferred embodiment of the single control plane system.

FIG. 2 is a flow diagram of a basic process for creating a new warehouse reference.

FIG. 3 is a flow diagram of a basic process for ingesting data into a data warehouse.

FIG. 4 is a flow diagram of a process for querying and presentation using the single control plane.

FIG. 5 is a flow diagram of a process for cold to hot migration triggered by query counter.

FIG. 6 is a flow diagram of a process for hot to cold migration triggered by query counter.

FIG. 7 is a flow diagram of a process for data migration into a new data warehouse and pruning of data in the old data warehouse.

FIG. 8 is a symbolic modelling (through an entity relationship diagram (ERD)) of a migration from a first data warehouse into a second data warehouse.

FIG. 9 is a logical diagram illustrating a single logical data center for US, Canadian and European data.

FIG. 10 is a logical diagram illustrating the data of FIG. 9 but split into separate American, Canadian and European regional data centers.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including in object-oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example, and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a standalone computer, a server, a server farm, virtual machines, on the mobile device as a stand-alone software package; partly on the mobile device and partly on a remote computer or remote computing device or entirely on the remote computer or server or computing device. In the latter scenario, the remote computers may be connected to each other or the mobile devices through any type of network, including a local area network (LAN) or a wide area network (WAN), or the connection may be made to the internet through a mobile operator network (e.g. a cellular network); WiFi, Bluetooth etc.

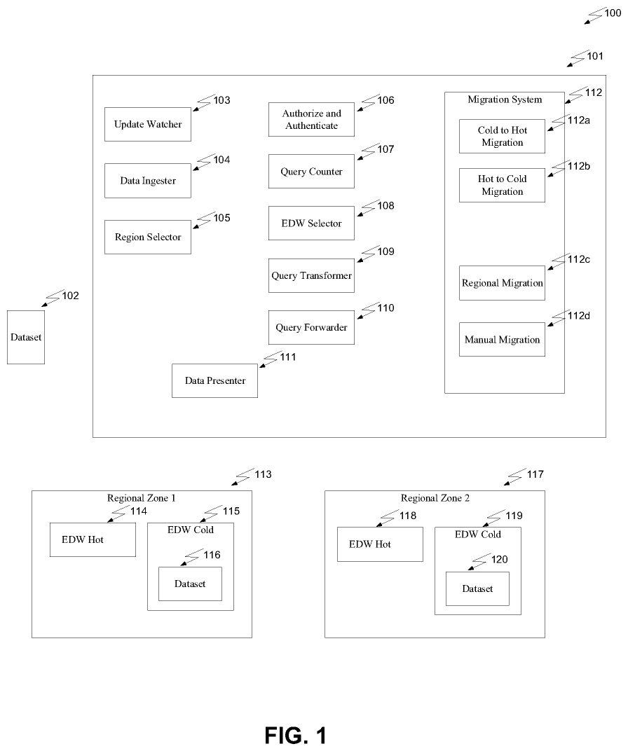

FIG. 1 shows one embodiment of a single control plane for ingestion and querying of data 101. For example, the single control plane for data ingestion may be used to house Big Data spread over multiple geographic locations which can be queried without necessarily knowing the specific geographic location of the data sought.

A Single Control Plane (SCP) provides a single system for managing the integrations of various datasets coming from possibly various computer systems located in possibly different geographic locations. It is intended to be the controller to manage the ingestion of a dataset from one location into a specified data warehouse. It will manage the connections to the data warehouses so each user adding new data into the system need not maintain a manifest of connection credentials to various data warehouses, but instead need only interact with a single system and select which already pre-configured warehouse data should be loaded into.

It also manages the querying of these data warehouses after they have had data loaded into them so various users need not maintain a manifest of connection credentials, or even know that one dataset may reside in a different data warehouse than another, but instead the single control plane maintains the list of pre-configured warehouses, and the record of which dataset has been loaded where, so when a user queries the data, the system automatically and seamlessly forwards that query to the appropriate data warehouse.

This allows a layer of abstraction away from the user to not only reduce the amount of complexity of dealing with many data warehouses, but also seamlessly protects the user from a migration event where a dataset has been moved from one data warehouse to another, breaking a configured integration of said data.

This also adds a layer of security because the single control plane can have global visibility into who is querying data and from where but can also cut-off access for a user for all data warehouses at once.

Big Data refers to large datasets that are too large or too complex to be dealt with using traditional data processing techniques. Big Data challenges include capturing data, data storage, data analysis, search, sharing, transfer, visualization, querying, updating, information privacy and data source.

Data ingestion is a process by which data is moved from one or more sources to a destination where it can be stored and further analyzed. The data might be in different formats and come from various sources, including RDBMS, other types of databases, S3 buckets, CSVs, or from streams. Since the data comes from different places, it needs to be cleansed and transformed in a way that allows it to be analyzed together with data from other sources. Otherwise, the data is like a bunch of puzzle pieces that do not fit together and cannot be related to, or used together.

Data can be ingested in real time, in batches, or in a combination of the two (this is called lambda architecture). When data is ingested in batches, data is imported at regularly scheduled intervals. This can be useful when there are processes that run on a schedule, such as reports that run daily at a specific time. Real-time ingestion is useful when the information gleaned is very time-sensitive, such as data from a power grid that must be monitored moment-to-moment. Data can also be ingested using a lambda architecture. This approach attempts to balance the benefits of batch and real-time modes by using batch processing to provide comprehensive views of batch data, while also using real-time processing to provide views of time-sensitive data.

The system and method of a single control plane data ingestion 101 may contain many different sub-systems, modules, and or components. The number and combination of the different sub-systems, modules, and or components comprising the system and method of invention may vary from one implementation to the other.

Dataset 102 is the external dataset residing in a system external to the invention and is to be ingested using the single control plane methods described elsewhere.

The Update Watcher 103 module is responsible for periodically checking the external dataset 102 to determine if it has been updated since it was last ingested. It uses a variety of heuristics to determine if an update has occurred such as the data modified header, ETAG header, or checksum. As an example, if the dataset is updated by another system, the update watcher will periodically check on a pre-specified schedule on the aforementioned clues to determine if an update has occurred and if it has been, perform a new ingestion.

The Data Ingester 104 module is responsible for ingesting data and storing it in the system according to the data residency or performance needs.

The Region Selector 105 module is responsible for determining the region of the data. As an example, the Region Selector analyzes the source of the data IP address geolocation, and other clues or rulesets, and selects the right data warehouse based on the determined geolocation.

The Authorize and Authenticate 106 module is responsible for managing the access to the system. Any time a user attempts to log into the system the Authorize and Authenticate module verifies the user credentials e.g. user name and password, and only provides access to the system and its resources after these credentials have been verified.

The Query Counter 107 module is responsible to keep a count of all the user queries that are sent to the system. The Query Counter module manages a log of the different queries made to the system of invention and maintains a count that is incremented each time a new query is made. In one embodiment of the invention the query counter maintains a frequency count. In one embodiment of the invention the different queries made by users to different datasets are logged and counted separately and the frequency of data access is determined and stored.

The EDW (Enterprise Data Warehouse) Selector 108 module is responsible for selecting the relevant data warehouse. For example, an enterprise may have more than one data warehouses located in different geographical regions. Typically, data warehouses are central repositories of integrated data from one or more disparate sources and may store current and/or historical data in a single place.

Data stored in a warehouse may be uploaded from different operational systems e.g. data from sales and/or data from marketing activities. Such data may pass through an operational data store and may require data cleansing for additional operations to ensure data consistency and quality prior to being stored in the data warehouse.

The Query Transformer 109 module is responsible for transforming a user query to a database query that abstracts away differences in the way certain databases process queries. As an example, data stored in one data warehouse may be in an SQL database while data stored in a second data warehouse may be in a document-oriented database, therefore the Query Transformer transforms the user query into a format which the data warehouse that needs to be accessed can understand.

The Query Forwarder 110 module is responsible for taking the transformed query, connecting to the relevant data warehouse and executing that query on the warehouse. As an example, the Query Forwarder maintains a connection pool to various data warehouses and sends the transformed query to the desired warehouse.

A connection pool is a cache of database connections maintained so that the connections can be reused when future requests to the database are required. Connection pools are used to enhance the performance of executing commands on a database.

The Data Presenter 111 module is responsible for taking the result set from the data warehouse and presenting it in a consistent format despite various nuances in the way certain warehouses return and present data.

The Migration System 112 module is responsible for moving the data from one warehouse to another in the event of a migration request coming up. As an example, data is moved from a Hot warehouse to a Cold warehouse based on events in the system e.g. analysis of the Query Counter frequency.

The Cold to Hot Migration 112a module is responsible for migrating the data that is being used more than a given threshold and should be moved from the cold storage where it was put in the beginning as it was less frequently queried to hot storage that is capable of very fast and concurrent processing. As an example, an in-memory database is an example of hot storage.

The Hot to Cold Migration 112b module is responsible for is responsible for migrating the data that is being used less than a given threshold and should be moved from the hot storage where it was put in the beginning as it was more frequently queried. In one embodiment of the invention moving data from a hot storage to cold storage is to improve costs, as hot storage is generally more expensive whereas cold storage is generally less expensive. Object storage is an example of cold storage.

The Regional Migration 112c module is responsible for migrating the data from one region to another. As an example, data is moved from a data warehouse in US to EU to comply with the data residency requirements.

The Manual Migration 112d module is responsible for migrating the data based on the manual commands of a user of the system. As an example, a sysadmin moves data between different warehouses.

The diagram in FIG. 1 shows one embodiment where there are two regional zones, Regional Zone 1 113 and Regional Zone 2 117. As an example, an organization may operate in multiple countries and may maintain multiple regional zones preferably one in each of its country of operation to comply with data residency requirements.

In another scenario there may be more than one regional zone in a large country to ensure data and system redundancy. For example, an organization may have multiple zones in the USA, one on the East Coast for the eastern states, one on the West Coast for the western states, and one in the south for the central states.

Regional Zone 1 113 depicts one geographical regional zone for example it is located in Europe Regional Zone 1 113 may have more than one Enterprise Data Warehouses in it for example one that stores datasets used frequently while another stores historical data used less frequently.

EDW Hot 114 (Enterprise Data Warehouse) Hot located in Regional Zone 1 113 refers to a data warehouse that stores datasets that are queried more often and may be implemented using an in-memory database, or other, that provides faster access time. As an example Regional Zone 1 may be located in Paris, France.

EDW Cold 115 (Enterprise Data Warehouse) Cold located in Regional Zone 1 113 refers to a data warehouse that stores datasets less frequently queried and may be implemented using a disk-based data storage.

Dataset 116 residing in the EDW Cold 115 is located in the Regional Zone 1 113.

Regional Zone 2 117 depicts a second geographical regional zone for example it is located in the USA. In one embodiment of the invention an organization may operate in multiple countries and may maintain multiple regional zones preferably one in each of its country of operation.

EDW Hot 118 (Enterprise Data Warehouse) Hot located in Regional Zone 2 117 refers to a data warehouse that stores datasets that are queried more often and may be implemented using an in-memory database that provides faster access time.

EDW Cold 119 (Enterprise Data Warehouse) Cold located in Regional Zone 2 117 refers to a data warehouse that stores datasets less frequently queried and may be implemented using a disk based data storage. As an example Regional Zone 2 may be located in New York, N.Y. USA.

Dataset 120 residing in the EDW Cold 119 located in the Regional Zone 2 117.

In one embodiment, a Pre-load Cache module caches the result of the transformation that the Ingester performs before it is loaded into the data warehouse. This enables the system to efficiently and rapidly load datasets into a different data warehouse without the need to perform the ingestion repeatedly and requiring that the external source be still accessible/available.

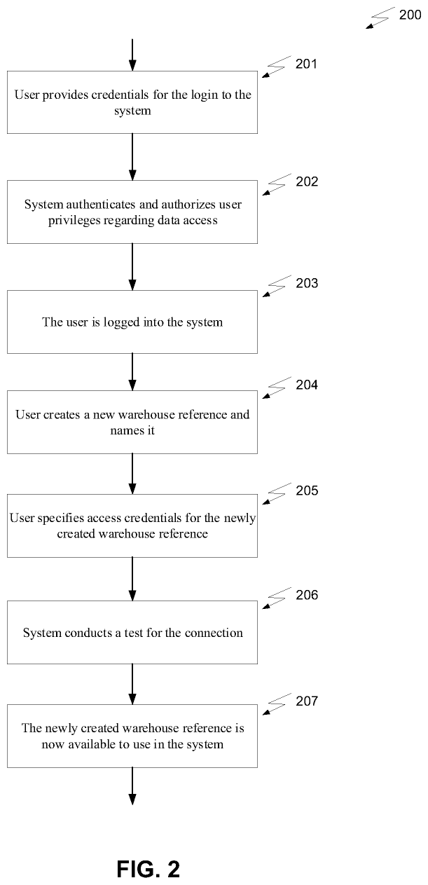

FIG. 2 shows one embodiment 200 illustrating a basic method using a single control plane for data ingestion. The user provides credentials for the login to the system 201, and then the system authenticates and authorizes the user privileges regarding the user's data access 202.

The user is logged into the system 203 and based on his system access privileges, the user is able to query and access the different datasets stored in the various data warehouses associated with the system.

In order to prepare a new data warehouse, the user creates a new warehouse reference and names it 204, specifies and enters the access credentials and meta information such as geographic location information or data warehouse type.

The user specifies access credentials for the newly created warehouse reference 205, and provides the connection details e.g. a URL or connection string.

The system conducts a test for the connection 206, which may be automated or manually triggered. For example, the system may test the credentials and connectivity and perform automated diagnostics such as determining that the warehouse type is in fact the type that the user specified and that the version is supported.

The newly created warehouse reference is now available to use in the system 207, and users can access it using the reference to the data warehouse specified for it.

The present system and methods aim to remove the complexity from the application layer by providing a single control plane for data access. Thus, the application only needs to connect with the single control plane which in turn enables it to connect to the various data warehouses associated with it.

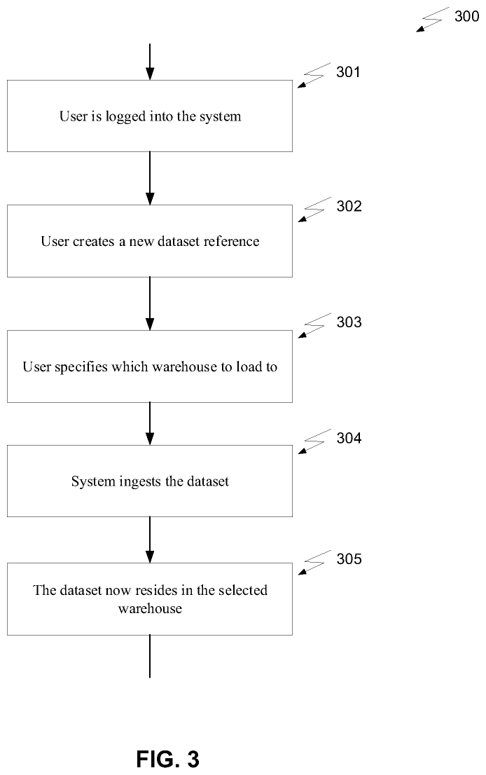

FIG. 3 shows one embodiment of the method 300. The user is logged into the system 301 and is able to query and access the datasets stored in the different data warehouses.

The user creates a new dataset reference 302, e.g. with the meta information regarding its location (URL).

The user specifies which warehouse to load to 303. For example, using an Admin Console the user specifies that the data is to be loaded to the EU warehouse to comply with the data residency requirements.

The system ingests the dataset 304. For example, the system may transforms the data to the required format for the selected data warehouse, such as the EU cold storage warehouse.

The dataset now resides in the selected warehouse 305. For example, EU sales and marking data now resides in a data warehouse located in EU.

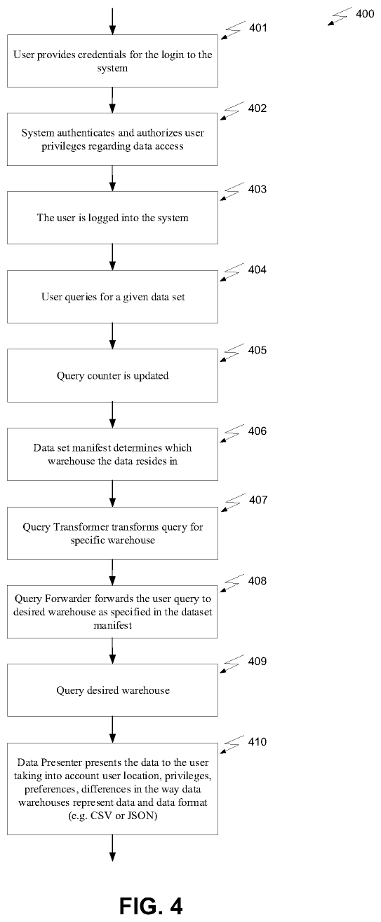

FIG. 4 shows one embodiment of the invention 400. The user provides credentials for login to the system 401.

The system authenticates and authorizes the user privileges regarding data access 402.

The user is logged into the system 403 and is able to query and access the datasets stored in the different data warehouses.

The user queries for a given dataset 404, e.g. the user queries for the sales data of a certain product in EU for the last quarter.

The query counter is updated 405. The query counter maintains a running log of the different queries made to the system of invention and the query count is incremented. For each of the different datasets a different and distinct query count is kept in the system. This enables the system to maintain and analyze the frequency of data access on a granular basis.

The dataset manifest determines which warehouse the data resides in 406. For example, the sales data queried by the user is located in EU.

The Query Transformer transforms the query for the specific warehouse 407. For example, the Query Transformer may transform the query for a specific warehouse where the sales data resides e.g. the sales data is stored in an SQL database. In this example, the Query Transformer transforms the query into a SQL statement.

If the data was stored in a document-oriented database or NoSQL database which is geared towards storing documents, the Query Transformer would take the same user query and transform it into a document-oriented query statement.

The Query Forwarder forwards the user query to desired warehouse as specified in the dataset manifest 408.

The query is directed (forwarded) to the desired warehouse 409. For example, the system executes the queries on the desired warehouse to extract the said EU product sales data.

The Data Presenter presents the data to the user taking into account user location, privileges, preferences, differences in the way data warehouses represent data and data format 410. The Data Presenter may also take the locality of data presentation into account e.g. formatting the numbers, figures and dates into EU or US variants to match the data presentation with the location of the user.

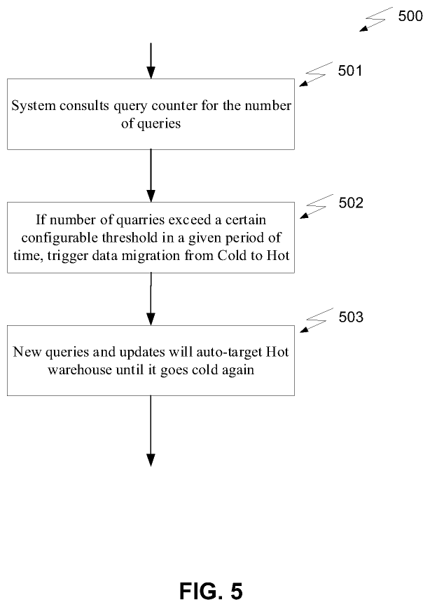

FIG. 5 shows one embodiment 500. The system consults the query counter for the number of queries 501. The query counter maintains a log of the different queries made to the system of invention and maintains a count that is incremented each time a new query is made. In one embodiment the different queries made by users to different datasets are logged and counted separately. In one embodiment the query counter maintains a frequency count. In one embodiment the different queries made by users to different datasets are logged and counted separately and the frequency of data access is determined and stored.

If the number of queries exceeds a certain configurable threshold in a given period of time, the system triggers a data migration from Cold to Hot 502. The threshold is preferably configurable. Thus, if a dataset is accessed quite frequently by users, then the system migrates said dataset from Cold EDW to Hot EDW.

New queries and updates will target the Hot warehouse until it goes cold again 503.

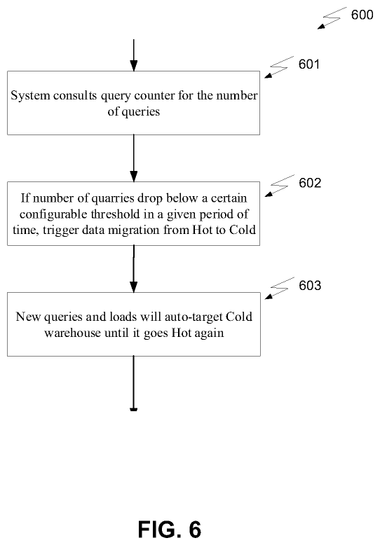

FIG. 6 shows one embodiment 600. The system consults the query counter for the number of queries 601. The query counter maintains a log of the different queries made to the system of invention and maintains a count that is incremented each time a new query is made. In one embodiment the different queries made by users to different datasets are logged and counted separately.

If the number of queries drops below a certain configurable threshold in a given period of time, trigger data migration from Hot to Cold 602.

New queries and loads will target Cold warehouse until it goes Hot again 603. This is tracked based on the query counter.

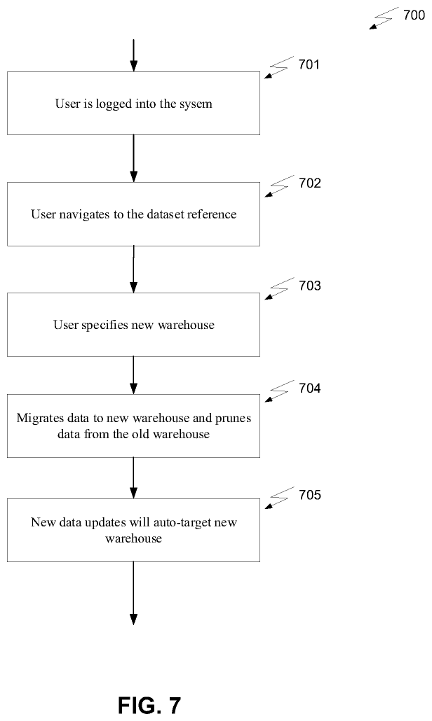

FIG. 7 shows one embodiment 700. The user is logged into the system 701 and is able to query and access the datasets stored in the different data warehouses.

The user navigates to the dataset reference 702.

The user specifies a new warehouse 703.

The system migrates data to a new warehouse and prunes data from the old warehouse 704.

Data pruning refers to a system task that automatically or manually deletes old revisions of data ingests to free up room in the system. This can be configurable by dataset to automatically be performed by the system after a new ingest happens or manually when a sysadmin decides to.

New data updates and queries will target new warehouse 705, as driven by switching of load and query markers.

Every dataset may have a Load Marker and a Query Marker associated with it. The Load Marker may be composed of, amongst other information fields, a warehouse reference, a state, a start time and an end time. The states for the Load Marker may be “loading”, “loaded” and “failed”.

The Query Marker may be composed of a warehouse reference and a state. The states of the Query Marker may be “inactive” and “active”.

The Load Marker denotes where the next load of the dataset should be directed to whilst the Query Marker denotes where the dataset current resides in its entirety and where queries to the dataset shall be directed.

Initially when a dataset is being loaded into a first warehouse (warehouse1) the Load Marker has a warehouse reference of “warehouse1” and its state is “loading” and the Query Marker has a warehouse reference of “warehouse1 and its state is “inactive”. This implies that the data from the dataset is being loaded into the warehouse and it is not available for a user to query.

When the dataset has loaded in the warehouse the state of the Load Marker changes to “loaded” and the state of the Query Marker becomes “active”; while the warehouse reference for both markers remains “warehouse1”. At this point user queries for this dataset can be directed to this warehouse (warehouse1).

As the dataset is migrated from the first warehouse (warehouse1) to the second warehouse (warehouse2) the Load Marker now has a warehouse reference of “warehouse2” and its state is “loading”. While the Query Marker still has the warehouse reference of “warehouse1” and its state is “active”. This enables a user to continue to query the dataset from the first warehouse (warehouse1) while the data is being migrated to the second warehouse (warehouse2) without any interruptions.

Once the data is migrated to the second warehouse (warehouse2) the Load Marker warehouse reference continues to be “warehouse2” but its state changes to “loaded”. At this point the Query Marker data warehouse reference changes to “warehouse2” and its state continues to be “active”. From this point on, all new user queries will be directed to the second warehouse (warehouse2). Optionally after the migration is complete, the dataset may now be purged from the first warehouse (warehouse1).

During this entire process the user querying the data is unaware of any changes or migrations of the dataset and does not need to make any changes to their queries. And the queries remain uninterrupted during this entire process.

Whether the dataset is moved from cold storage to hot storage, or is moved from one regional warehouse to another regional warehouse automatically, or the sysadmin has moved it from one region to another, the user remains unaware of the moves and free of having to keep a track of the data moves.

As data is migrated or unavailable from one region or one data warehouse a map or list or manifest of data warehouses (and associated load and query markers) is updated accordingly.

If data is moved from one warehouse to another or is available at a different location, users do not need to know the details about the data location as their access remains abstracted from the underlying location of the dataset.

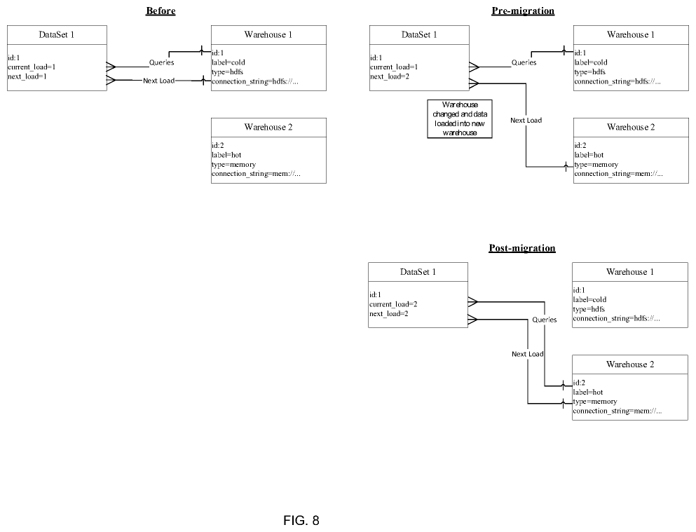

FIG. 8 depicts through an ERD model a pre- and post-migration switching of internal load and query markers. The system and method enables keeping track of the data moves and relieves the user from having to know where the data resides at the time of query.

In the event of a user query to the system, the Query Selector then consults the map or manifest to determine which warehouse the data currently resides in and which type of warehouse it is. The request then gets sent to the Query Transformer which transforms the user query into the relevant warehouse query based on its type. The Query Forwarder then actually sends that query to the relevant warehouse and gathers the results to be sent to the Query Presenter.

If a migration event is triggered, the migrator will update the dataset Load Marker with the desired warehouse. Then a load event is triggered and the Ingester loads into the new warehouse according to one embodiment, from the Pre-load Cache. In another embodiment of the invention the load may be a direct warehouse-to-warehouse transfer. Once the load is completed, the Dataset Query Marker is updated with the new warehouse and user queries begin to target the new warehouse. The Teardown component then cleans up the load from the previous warehouse.

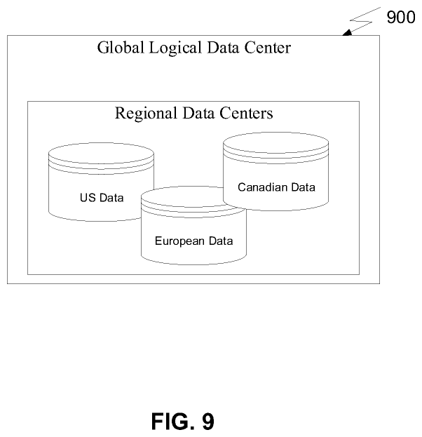

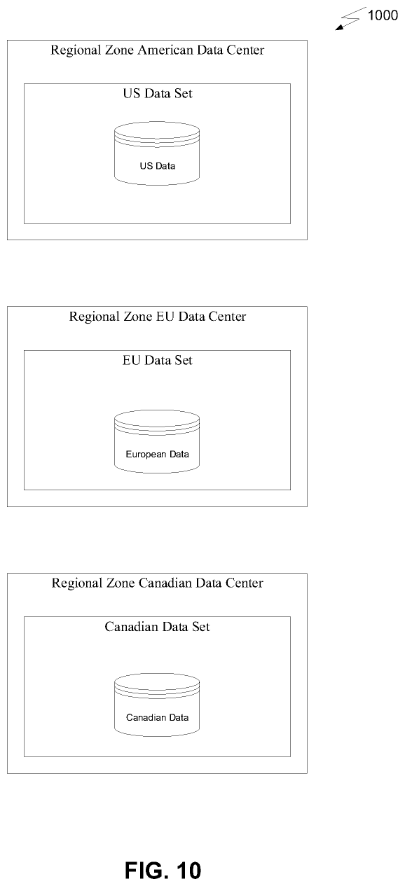

FIGS. 9 and 10 illustrate a before-migration 900 and after-migration 1000 arrangement of data warehousing by geographic region. In FIG. 9, datasets for the US, Canada and Europe are stored in one global logical data center. Post-migration, as shown in FIG. 10, the datasets are in individual regional data centers. This migration may be necessitated for legal compliance (e.g. EU data protection) or may be for other technical or logistical reasons that are not obvious to users. The present method and system allow data to be queried by a user without knowledge of, or regard to, the actual location of the data.

The intent of the application is to cover all such combinations and permutations not listed here but that are obvious to persons skilled in the art. The above examples are not intended to be limiting but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to persons skilled in the art.

What is claimed is:

1. A method of ingesting datasets into existing data warehouses, the warehouses being associated with data warehouse references, comprising:
receiving from a user a selection of a data warehouse reference into which a dataset is to be loaded;
accessing the dataset and determining its regional and format particulars;
determining available data warehouses that are associated with the selected data warehouse reference;
based on the regional and format particulars, selecting a data warehouse from the available data warehouses;
retrieving a current address of the selected data warehouse; and
ingesting the dataset directly into the selected data warehouse at the current address without further input from the user or knowledge of the current address by the user.

2. The method of claim 1, further comprising configuring, cleaning or reformatting the dataset prior to loading it into the selected data warehouse.

3. The method of claim 1, further comprising making the dataset available for query once ingested based on the data warehouse reference.

4. The method of claim 3, wherein the query is tailored for a preferred query format of the data warehouse.

5. The method of claim 1, wherein a region of the dataset matches the region of the selected data warehouse.

6. The method of claim 1, wherein a language of the dataset matches a language of the selected data warehouse.

7. The method of claim 1, wherein a format of the dataset matches a format of the selected data warehouse.

8. The method of claim 1, wherein the ingesting is by a process selected from: real time, batchwise, and lambda architecture.

9. The method of claim 1, wherein a load marker is set or reset before the ingesting step.

10. The method of claim 1, wherein a query marker is set or reset after the ingesting step.

11. A method of migrating between existing data warehouses having ingested data, the warehouses being associated with warehouse references, comprising:
establishing a first data warehouse associated with a data warehouse reference, and loading data into the first data warehouse;
establishing a second data warehouse;
when migration from the first to the second data warehouse is to occur, switching a load marker from the first to the second data warehouse;
wherein a new revision of the dataset is automatically directable after the migration.

12. The method of claim 11, further comprising moving data from the first data warehouse into the second data warehouse.

13. The method of claim 11, further comprising copying data from the first data warehouse into the second data warehouse.

14. The method of claim 11, further comprising deleting data from the first data warehouse after the migration.

15. The method of claim 11, further comprising switching a hot/cold marker on the first data warehouse to cold after the migration.

16. The method of claim 11, further comprising switching a hot/cold marker on the second data warehouse to hot after the migration.

17. The method of claim 11, wherein the second data warehouse is in a different region than the first data warehouse.

18. The method of claim 17, further comprising moving or copying data from the first data warehouse into the second data warehouse, and reformatting the moved or copied data for the region of the second data warehouse.

19. The method of claim 11, further comprising automatically ingesting new datasets into the second data warehouse after the migration.

20. The method of claim 11, further comprising automatically switching a query marker from the first to the second data warehouse after the migration.

21. The method of claim 20, further comprising receiving a query related to a dataset and automatically directing the query to the second data warehouse.

22. The method of claim 21, wherein a query counter is updated.

23. The method of claim 22, further comprising setting or resetting a hot/cold marker based on the query counter.
